(19) United States
(12) Patent Application Publication
(10) Pub. No.: US 2008/0116303 A1
(43) Pub. Date: May 22, 2008

(54) Method for Improved Agitator Milling of Solid Particles

(76) Inventors: Volker Jurgens, Kirchhundem (DE); Siegfried Bluemel, Ratingen-Eggerscheid (DE); Mark Kaminski, Leverkusen (DE); Joerg Friedrich, Leichlingen (DE)

Correspondence Address: Locke Lord Bissell & Liddell LLP;Attn: Michael Ritchie, Docketing, 2200 Ross Avenue, Suite # 2200, DALLAS, TX, 75201-6776, US

(21) Appl. No.: 11/935,530

(22) Filed: Nov. 6, 2007

Related U.S. Application Data
(60) Provisional application No. 60/869,155, filed on Dec. 8, 2006.

(30) Foreign Application Priority Data
Nov. 21, 2006 (DE) 10 2006 054727.6

(51) Int. Cl. B02C 17/00

(52) U.S. Cl. 241/21

(57) ABSTRACT

A method for the agitator milling of solid particles, particularly of titanium dioxide, where the suspension with a maximum particle size of 2 μm is milled in closed-circuit mode and subjected to continuous classification by sedimentation in a tank after each pass through the mill. The method results in milled solid particles with narrower particle size distributions, particularly titanium dioxide pigments with improved optical properties, such as tinting strength and gloss.

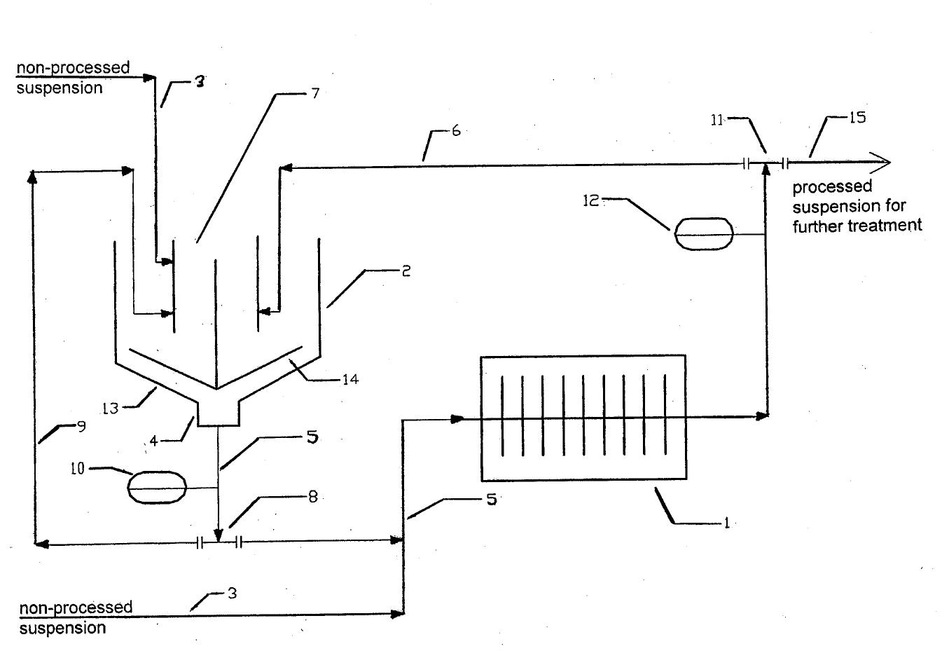

### RELATED APPLICATION

This application claims the benefit of U.S. Provisional Patent Application Ser. No. 60/869,155 filed Dec. 8, 2006 and the benefit of DE 10 2006 054 727.6 filed Nov. 21, 2006.

### TECHNICAL FIELD OF THE INVENTION

The invention relates to a method for improving the quality and flexibility of the agitator milling of solid particles, particularly of titanium dioxide.

### BACKGROUND OF THE INVENTION

In principle, an agitator mill consists of a vessel that is partially filled with spherical grinding media made, for example, of ceramic material, steel or glass, or with specially treated sand, and in which, for example, a shaft with several discs arranged in stages rotates. The mill base suspension is pumped through the vessel, during which process shear, pressure and impact forces bring about dispersion and disagglomeration or comminution of the mill base particles. The grinding media are separated from the mill base suspension at the mill outlet. Agitator mills as such are known, and are commonly used to comminute or disagglomerate solid particles, particularly titanium dioxide particles (e.g. U.S. Pat. No. 4,989,794; U.S. Pat. No. 5,356,470).

In agitator milling, the targeted fineness of grind can be controlled via the type, size, density and quantity of the grinding media, via the shaft speed, the density of the suspension and via the throughput. A batch can also be pumped through the mill several times, either in multi-pass mode or in closed-circuit mode. Multi-pass mode means that the entire mill base batch is pumped through the mill before being fed in again. In closed-circuit mode, the mill base suspension is continuously recirculated by pumping. Generally speaking, a relatively broad particle size distribution is obtained in the event of a single pass through the mill.

U.S. Pat. No. 3,998,938 states that the same milling result can be achieved more effectively if, instead of being passed through a large-volume mill once, the mill base suspension is circulated through a smaller-volume mill several times at an elevated throughput rate. In this context, the milled suspension is pumped back into the mill either directly or via an intermediate tank. The intermediate tank is designed in such a way that the solid particles do not settle, but are kept in suspension.

During the milling process, the mill base suspension flowing through the mill is subject to a mixing process, the effect of which is that parts of the suspension remain in the milling chamber for different lengths of time, independently of the particle size. This results in a relatively broad residence time distribution for the particles. Increasing the number of passes or cycles brings about an improvement, i.e. the residence time distribution becomes narrower. Although this reduces the mean particle size, and also the coarse fraction of the suspended particles, the proportion of very fine particles increases at the same time. The overall particle size distribution curve shifts towards the fine range.

In the production of titanium dioxide pigments, the absolute particle size and the particle size distribution exert a decisive influence on the optical properties of the finished pigment, e.g. on the tinting strength (TS), the tone (spectral characteristic SC) and the gloss. Coarse components impair the gloss, while excessively fine components reduce the tinting strength, as does too broad a particle size distribution. The narrowest possible particle size distribution in the range from 0.2 to 0.4 μm is desirable. Prior to final coating with inorganic and/or organic compounds, titanium dioxide base material particles are customarily milled in such a way that they display the best possible particle size distribution.

Methods are known from the prior art that optimize milling inasmuch as the mill base is classified after each pass, only the coarse fraction being fed back into the mill in each case. Classification is performed either with the help of screens in the case of particle sizes in the cm range (U.S. Pat. No. 5,337,966) or with hydrocyclones in the case of aluminium hydroxide particles with particle sizes in the μm range (U.S. Pat. No. 4,989,794).

Milling processes are generally performed in batch mode or in continuous mode. Batch mode means that the material is processed consecutively, a certain quantity (batch) at a time. In continuous mode, on the other hand, fresh material is constantly fed into the system, while processed material is drawn off at the same time.

The method according to U.S. Pat. No. 4,989,794 is operated in batch mode. A hydrocyclone performs classification after each mill pass, the coarse fraction being fed back into the mill feed vessel. The fine fraction is again classified in the hydrocyclone. Recirculation of the coarse and fine fractions is continued until the required particle fineness is achieved. As is generally known, particle classification with hydrocyclones is not possible in the ultrafine range with particle sizes <2 μm. Moreover, the method according to U.S. Pat. No. 4,989,794 employs several vessels, which require not only capital spending, but also, and above all, space in a production facility.

U.S. Pat. No. 4,278,208 describes a comminution method for limestone particles in the mm range, in which at least 60% of the particles are comminuted to <2 μm. The method is operated in such a way that material having the required fineness is removed, the remaining coarse material being further comminuted. The fine fraction is separated with the help of a centrifuge, hydrocyclones or on the basis of gravitational sedimentation.

U.S. Pat. No. 5,080,293 and U.S. Pat. No. 5,199,656 describe a comminution device and a method for continuous wet-milling of solids. In this method, too, only the coarse fraction is returned to the wet-milling process, while the fine fraction is removed by screens. No particle sizes are indicated, but experience shows that screens only permit particle classification up to a particle size of approx. 100 μm.

### SUMMARY OF THE INVENTION

The present invention provides a milling method that permits targeted generation of a narrow particle size distribution of solid particles, particularly of titanium dioxide base material, in a particle size range <2 μm, that can be operated economically and handled flexibly, depending on the given mill base quality and capacity utilization, and that requires little additional space.

The method for milling solid particles in an agitator mill, includes:
a) a solid-particle suspension is provided, where the maximum particle size is 2 μm,
b) the suspension is pumped through the agitator mill,
c) the suspension is fed into a sedimentation tank, where the suspension undergoes classification by sedimentation,
d) the suspension is drawn off at the bottom of the sedimentation tank, and
e) pumped through the agitator mill again,
   where steps c) to e) are repeated until the solid particles display the required particle size distribution.

### BRIEF DESCRIPTION OF THE DRAWING

For a more complete understanding of the present invention and for further advantages thereof, reference is now made to the following Description of the Preferred Embodiments taken in conjunction with the accompanying Drawing which is a schematic illustration of a system for use with the present method.

### DESCRIPTION OF THE PREFERRED EMBODIMENTS

The subject matter of the invention is a method for operating agitator mills that is simple, can be handled flexibly, and with the help of which milled solid particles with narrow particle size distributions can be produced. In particular, the method according to the invention can be used to produce titanium dioxide pigments with improved optical properties, such as tinting strength, tone and gloss.

The invention is based on the knowledge that the particle size range of the mill base remains disadvantageously broad, even in closed-circuit mode, since both small and large particles have a similar residence time in the mill. The method according to the invention makes it possible to control the residence time of the particles in the mill as a function of the particle size, i.e. to feed coarser particles back into the mill appropriately more often than finer particles. The specific milling energy for coarser particles is increased in this way. In this context, the mill base is subjected to continuous classification by sedimentation after each pass through the mill, in that the milled particle suspension is fed into a sedimentation tank, the size and shape of which permits continuous particle sedimentation. Suspension displaying a higher concentration of coarse particles than the suspension as a whole is drawn off at the bottom of the sedimentation tank.

Were particle sedimentation to follow Stokes' law, sedimentation times of unsuitable length for practical purposes would be obtained for particles sizes of approx. 1 μm. With the method according to the invention, however, it is possible to reduce the coarse particle fraction >0.6 μm in less time than with closed-circuit milling without classification by sedimentation. Additional factors, such as flocculation and flow, probably play a role in this context.

Compared to the aforementioned methods (U.S. Pat. No. 4,989,794; U.S. Pat. Nos. 4,278,208; 5,080,293; 5,199,656), the method according to the invention is characterised in that the mill base batch is not classified into a fine fraction and a coarse fraction following the first pass through the mill, but subjected in its entirety to gradual classification and fed back to the milling process. In this way, a constant quantity of suspension is recirculated at a constant throughput rate.

In contrast to the aforementioned methods, the method according to the invention can also be used for finer particles sizes of roughly <2 μm, particularly for particles sizes of approx. 80%<1 μm, and requires less space since no additional apparatus is required, apart from the sedimentation tank, which can simultaneously serve as the feed vessel for the mill.

The closed-circuit milling method according to the invention is operated in batch mode. The FIGURE shows a schematic representation of a system for use with the method according to the invention, although this system is not intended to restrict the invention.

An agitator mill 1 and a sedimentation tank 2 are connected in a circuit via lines 5 and 6. Either a vertically or a horizontally installed mill can be used. The mill base batch 3 is pumped into the mill 1, either directly or via the tank 2. Not shown here are the mechanical screens or hydrocyclones customarily used at the outlet of agitator mills, which hold back the grinding media and remove broken grinding media and other coarse particles in the μm to mm range.

After passing through the mill 1, the suspension is fed into the sedimentation tank 2 from the top in such a way that it is not swirled up and the particles can settle undisturbed. This effect can, for example, be achieved by feeding into a stilling tank 7. Due to sedimentation, the coarser particles accumulate on the tank bottom 13, while the finer particles are kept in suspension for longer. The suspension containing the coarser particles is drawn off at the tank outlet 4 and again pumped via line 5 into the mill 1 and subsequently via line 6 back into the sedimentation tank 2. The cycle is continued until the mill base suspension displays the targeted fineness of grind (measuring station 12) and is discharged at the switch 11 via line 15 in order to be passed on for further treatment.

The density of the suspension drawn off at the tank outlet 4 is higher than that of the overall batch, but changes in the course of the recirculation process of a batch, leading to the mill 1 being charged with suspension of varying density. Depending on the operating conditions, and particularly at the start of closed-circuit milling of a batch, the suspension drawn off can display a very high density, which may possibly cause malfunctioning of the mill 1. An embodiment of the method avoids the occurrence of excessively high densities and allows the density of the feed suspension at the mill 1 to be regulated to a lower level. To this end, the density of the suspension drawn off at the tank outlet 4 is measured at the measuring station 10. If the density is above the target value, a partial flow of the suspension is drawn off via a bypass line 9 at the switch 8 and fed back into the tank 2. The density of the suspension drawn off at the tank outlet 4 declines as a result. Thus, a uniform density at the inlet of the mill 1 can be set via the quantity of suspension drawn off and returned at the switch 8.

A person skilled in the art is familiar with the individual parameters by means of which both the fineness of grind in the mill and the sedimentation of the particles, i.e. classification, can be influenced. They include, for example, the feed particle size, the density of the suspension, the throughput, the type, size, density and filling level of the grinding media, and the shaft speed of the mill. The size of the stilling tank 7 and the sedimentation tank 2 must be adapted to the batch size and the mode of operation of the mill 1. In a preferred embodiment, the interior of the tank tapers conically towards the bottom 13, such that the settling particles pass into the outlet 4. Advantageously, a raking unit (rotating scraper 14) can be installed on the bottom 13, by means of which the settling particles are conveyed to the outlet 4 without being swirled up.

The volume of the sedimentation tank is advantageously at least five times the mill volume, particularly at least ten times. In practice, it is also possible for several mills connected in parallel to operate in a circuit with one sedimentation tank.

The method according to the invention is particularly suitable for the wet-milling of titanium dioxide base material. In addition, it can be used wherever a narrow particle size distribution is to be achieved efficiently by agitator milling, e.g. in ore dressing.

### EXAMPLES

The invention is explained on the basis of the following examples, although the examples are not to be interpreted as a restriction.

### Example 1

An aqueous suspension of 500 g/l TiO₂ base material, produced by the chloride process, was used. The horizontally installed sand mill (Netzsch LME 20) had a volume of 20 l (gross) and was roughly 82% filled with 20/30 Ottawa sand (particle size 0.6 to 0.8 mm). The mill was operated in batch mode. The batch size was 300 l, corresponding to 150 kg TiO₂. The dispersant used was 0.1% by weight HMP (hexametaphosphate), referred to TiO₂. The suspension was milled both in closed-circuit mode with sedimentation according to the invention and in closed-circuit mode without sedimentation (according to the prior art). Three cycles with 150 kg/h were run in each case.

When milling according to the invention, the suspension was passed through an intermediate tank permitting classification of the particles by sedimentation after leaving the mill. A fraction of the suspension enriched with coarser particles was discharged at the tank bottom and pumped back into the mill.

For closed-circuit milling according to the prior art, the suspension was passed through an intermediate tank with running stirrer after leaving the mill, such that sedimentation of the particles was prevented.

The titanium dioxide particles were subsequently post-treated with inorganic oxides in identical fashion according to a standard specification before finally being dried and micronised. The finished pigment was tested for fines and coarse particles (<0.2 μm and >0.6 μm, respectively), and also as regards tinting strength (TS), tone (spectral characteristic SC), gloss and gloss haze.

### Example 2

An aqueous suspension of 500 g/l TiO₂ base material, produced by the chloride process, was used. The horizontally installed sand mill (Netzsch LME 20) had a volume of 20 l (gross) and was roughly 85% filled with zirconium oxide/Y-stabilised beads (SilibeadsZY®, particle size 0.5 to 0.7 mm). The mill was operated in batch mode. The batch size was 4000 l, corresponding to 2000 kg TiO₂. The dispersant used was 0.3% by weight HMP (hexametaphosphate), referred to TiO₂. The suspension was milled both in closed-circuit mode with sedimentation according to the invention and in closed-circuit mode without sedimentation (according to the prior art). Five cycles with 150 kg/h were run in each case.

When milling according to the invention, the suspension was passed through an intermediate tank of a volume of about 4 m³ permitting classification of the particles by sedimentation after leaving the mill. A fraction of the suspension enriched with coarser particles was discharged at the tank bottom and pumped back into the mill.

For closed-circuit milling according to the prior art, the suspension was passed through an intermediate tank with running stirrer after leaving the mill, such that sedimentation of the particles was prevented.

The titanium dioxide particles were subsequently post-treated with inorganic oxides as in Example 1 before finally being dried and micronised. The finished pigment was tested for fines and coarse particles (<0.2 μm and >0.6 μm, respectively), and also as regards tinting strength (TS), tone (spectral characteristic SC), gloss and gloss haze.

Test results:

| | Particle sizes | | | | | |
|---|---|---|---|---|---|---|
| | [% by weight] | | | | | Gloss |
| Closed-circuit mode | >0.6 μm | <0.2 μm | TS | SC | Gloss | haze |

Example 1

| | | | | | | |
|---|---|---|---|---|---|---|
| With sedimentation | 9 | 11 | 102.8 | 6.0 | 69 | 17 |
| Without sedimentation | 12 | 11 | 101.7 | 6.0 | 57 | 34 |

Example 2

| | | | | | | |
|---|---|---|---|---|---|---|
| With sedimentation | 5 | 15 | 103.3 | 6.7 | 76 | 24 |
| Without sedimentation | 6 | 15 | 102.4 | 6.6 | 66 | 39 |

Milling according to the invention reduces the proportion of coarse particles in the mill base and leads to improved tinting strength, gloss and gloss haze. The process is particularly suitable when using relatively coarse feeding material or feeding material with a broad particle size distribution.

### Test Methods

a) Particle Size Distribution

The particle size distribution is determined using a Sedigraph 5100 from Messrs. Micromeritics GmbH on the basis of ISO/DIS 13317-1 and ISO FDIS 13317-3:2000.

b) Tinting Strength (TS) and Tone (Spectral Characteristic SC)

The tinting strength and the tone of the pigment are determined after incorporation in a carbon black paste according to DIN 53165 at a pigment volume concentration of 17%. The grey paste prepared on an automatic muller is applied to a white Morest chart. A HunterLab PD-9000 calorimeter is used to determine the reflectance values of the film while wet. The TS and SC values derived therefrom are referred to an internal standard.

c) Gloss and Gloss Haze

The pigment is dispersed in a rapid-drying paint binder using an automatic muller. A drawdown of the dispersion is produced on a glass panel. The gloss (20°) and gloss haze are subsequently measured with a Haze-Gloss Reflectometer from Messrs. Byk-Gardner.

We claim:

1. A method for milling solid particles in an agitator mill, comprising:
a) providing a solid-particle suspension, wherein the maximum particle size is 2 μm,
b) pumping the suspension through the agitator mill,
c) feeding the suspension into a sedimentation tank, such that the suspension undergoes classification by sedimentation in the sedimentation tank,
d) drawing off the suspension at the bottom of the sedimentation tank, and
e) pumping the drawn off suspension again through the agitator mill,
wherein steps c) to e) are repeated until the solid particles display a desired particle size distribution.

2. The method according to claim 1, wherein the solid particles within the suspension include titanium dioxide.

3. The method according to claim 1, and further including:
raking the suspension with a raking unit located on the bottom of the sedimentation tank.

4. The method according to claim 1, and further including:
passing the suspension into the sedimentation tank via a stilling tank.

5. The method according to claim 1, wherein the volume of the sedimentation tank is at least five times the mill volume.

6. The method according to claim 1, wherein the volume of the sedimentation tank is at least ten times the mill volume.

7. The method according to claim 1, wherein
the density of the suspension pumped back into the mill at step e) is controlled by a partial bypass recirculation of the suspension into the sedimentation tank.

8. The method according to claim 1, wherein coarse particles in the μm to mm particle size range are held back and removed at the outlet of the mill by using screens.

9. The method according to claim 1 wherein coarse particles in the μm to mm particle size range are held back and removed at the outlet of the mill by using hydrocyclones.

10. The method according to claim 1, wherein a dispersant is included in the suspension.

11. The method according to claim 10 wherein the dispersant includes hexametaphosphate.
